(19) United States
(12) Patent Application Publication
(10) Pub. No.: US 2004/0217983 A1
(43) Pub. Date: Nov. 4, 2004

(54) Process for visually organizing informational concepts and relationships utilizing a matrix

(76) Inventor: Ken Forsse, Dana Point, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/821,655

(22) Filed: Apr. 8, 2004

Related U.S. Application Data
(60) Provisional application No. 60/461,703, filed on Apr. 9, 2003.

(51) Int. Cl. G09G 5/00; G03B 17/24

(52) U.S. Cl. 345/700; 345/961

(57) ABSTRACT

A matrix, having a primary cell and a plurality of secondary cells surrounding the primary cell is used to visually organize informational concepts and relationships. Primary objective or subject data is inserted in the primary cell. Data related to the primary objective or subject data, such as features or characteristics of the primary objective or subject data, is inserted into the surrounding secondary cells. Due to the organization of the related data and the surrounding secondary cells, the primary objective or subject can be interpreted and comprehended more easily.

### RELATED APPLICATION

This application claims priority to U.S. Provisional Application Serial No. 60/461,703, filed Apr. 9, 2003.

### BACKGROUND OF THE INVENTION

The present invention generally relates to systems and methods for organizing information. More particularly, the present invention relates to a matrix system which enhances the comprehension, organization and presentation of thoughts and actions in an easily understood visual format.

Just as there is a natural order in the universe, there can be a natural order for the things that effect and influence people's daily lives, including their relationships and the way they relate to the world. Such a conceived natural order should apply, whether those relationship are personal, social, political, or within a business environment.

The forms of natural order are all around us. If we will only stop to notice. They are mathematical, they are geometric, they are dimensional. They provide organizational formats for things which are related, they provide balance, they provide consistency, and they provide flexibility. They are not magical, they are simply there for us to observe and to use.

When items are made up of multiple dimensions we can recognize a vast number of separate items. We can recognize hundreds of faces, words, objects, etc. because those things differ in multiple ways. So, the total number of things that we can learn to recognize is quite large. Nonetheless, if a list of multiple-dimensional items is presented to us as an unrelated stream of data, we still have difficulty recalling them correctly. The process for accomplishing greater recognition and memory is clustering or grouping items into chunks.

For example, someone who is learning Morse Code begins by hearing an unintelligible stream of dots and dashes. But after a time, those sounds become clustered into and recognized as letters and eventually words and sentences. In the same way, learning of all kinds is enhanced by our ability to cluster, organize and collate information based upon relationships.

Most subjects can be readily segmented into a limited number of elements or features. A division of less than five elements usually leaves out one critical element. Conversely, more than seven elements begins to become too complex. But, it has been found that six is the ideal mix of elements. The combination of the numbers six and seven has been the subject of a wide array of experiments, such as that described in a 1956 article by George A. Miller, entitled “The Magical Number Seven, Plus or Minus 2: Some Limits on Our Capacity for Processing Information”. The experiments were based on various methods of communicating one-dimensional information and measuring the ability of people to correctly retain that information. The objective was to increase the amount of data until the point of absolute judgement had been exceeded. Absolute judgement was described as the point beyond which mistakes would be made.

One test in George Miller's book involved people identifying or classifying audio tones of different frequencies. Numbers were assigned to a variety of tones. Then, when hearing individual tones, the subjects were asked to identify them by number. People who possessed absolute pitch could identify many tones. But among people who were not musically sophisticated, results indicated that the listener became confused after identifying six different tones. In a similar test involving the identification of different audio volumes, the accuracy began to fall off after five different volumes. In identifying squares of different sizes, the number was about five. The absolute judgement for identifying size, hue, brightness, duration, intensity, etc. averaged approximately six. In another test, subjects counted dots which were flashed on a screen for one/fifth of a second. It was found that the patterns of up to five or six dot subjects never made mistakes. Below seven dots the subjects were said to “subtize”. Above seven dots, they were said to “estimate”. The findings of these and other experiments indicate that the average number of one-dimensional items can be comprehended without error is between five and seven.

Accordingly, there is a continuing need for a system and method for facilitating the organization, recollection and comprehension of information. The present invention fulfills these needs and provides other related advantages.

### SUMMARY OF THE INVENTION

The present invention resides in a process for creating a visualization system for discovering, interpreting, creating, presenting and comprehending information. The process and visualization matrix of the present invention can be applied to a wide range of endeavors, including strategic planning, problem solving, creative organization, concept of visualization, business relationship analysis, school of objective delineation, management training, media presentation and others.

The process for visually organizing informational concepts and relationships comprises the steps of providing a matrix having a primary cell and two to seven secondary cells surrounding the primary cell. Typically, the number of surrounding cells is six. Preferably, the primary cell and surrounding secondary cells are hexagonal. Primary objective or subject data is inserted in the primary cell. Data related to the primary objective or subject data is inserted into the surrounding secondary cells. Typically the related data comprises identified features or characteristics of the primary objective or subject data. This allows the interpretation and comprehension of the primary objective or subject by means of the organization of the related data and the surrounding secondary cells.

In another embodiment, instead of identifying and determining features or characteristics of the primary objective or subject data to be inserted into the surrounding secondary cells, known data or factors are disposed in the surrounding secondary cells. The known data or factors are compared to derive primary objective or subject data, which is inserted into the primary cell. The known data or factors typically comprise features or characteristics of the primary objective or subject data.

In yet another embodiment, multiple matrices are layered. That is, a first matrix having a primary cell and six secondary cells surrounding the primary cell is provided. Primary objective or subject data is inserted in the primary cell. Data related to the primary objective or subject data is inserted into the surrounding secondary cells. A second matrix, having a primary cell and six secondary cells surrounding the primary cell, is generally vertically aligned with the first matrix. Once again, primary objective or subject data is inserted into the primary cell of the second matrix, and related data is inserted into the surrounding secondary cells. The organization of the related data and the surrounding secondary cells enables the interpretation and comprehension of the primary objective or subject data. In such layered matrices, the primary cell of each matrix may be assigned the same objective or subject data. In this case, the surrounding secondary cell data of each matrix can be vertically interchangeable.

In yet another embodiment, a cyclic matrix is created. This is done by removing related data from a surrounding secondary cell and inserting new related data into at least one of the surrounding secondary cells. The primary objective or subject data is reinterpreted in light of the new related data in the surrounding secondary cells.

In some instances, it is desirable to create a balance in the matrix by arranging the related data such that dissimilar related data are disposed in secondary cells on generally opposite sides of the primary cell.

In each of the embodiments described above, the data from a surrounding secondary cell can be inserted into a primary sub-cell of a sub-matrix. Features and characteristics of the data are identified and inserted into a plurality, typically six, secondary sub-cells of the sub-matrix so as to focus on this data and expand the analysis.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a diagrammatic view of a matrix used in accordance with the present invention, and having a secondary cell thereof expanded into sub-topics;

FIG. 2 is a diagrammatic view of the matrix of the present invention, illustrating the creation of a plurality of secondary cells based upon subject data within a central or primary cell thereof;

FIG. 3 is a diagrammatic view illustrating balance within the matrix;

FIG. 4 is a diagrammatic view of a matrix embodying the present invention, illustrating the relationship between topics or data in secondary cells as compared to a primary objective or subject within a central primary cell of the matrix, and the substitution of secondary cells;

FIG. 5 is a diagrammatic representation of a cyclical matrix used in accordance with the present invention;

FIG. 6 is a diagrammatic representation of a plurality of matrices of the present invention layered on top of one another, and illustrating an aptitude test embodying the present invention;

FIGS. 7-12 are diagrammatic representation of matrices illustrating the aptitude test of the present invention; and

FIG. 13 is an environmental view of a computer display and keyboard, illustrating the matrix of the present invention incorporated into educational software.

### DETAILED DESCRIPTION OF THE PREFERRED EMBODIMENTS

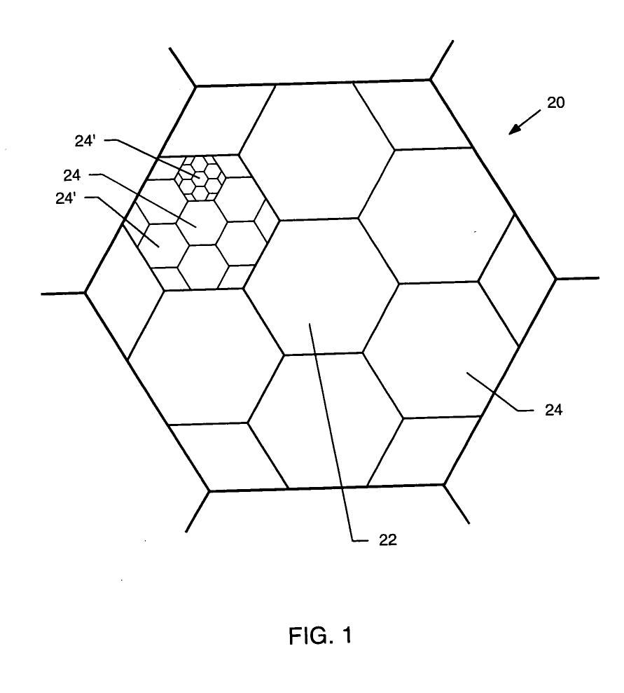

The present invention resides in a method which provides a visual graphic format that greatly enhances the comprehension, organization and presentation of thoughts and actions. The visual graphic format is in the form of a matrix 20, as illustrated in FIG. 1. The matrix 20 includes a primary cell 22 disposed in the center of a plurality of surrounding cells 24. The primary central cell 22 is preferably surrounded by between two to seven secondary cells 24. In a particularly preferred embodiment, the number of secondary cells 24 surrounding the primary cell 22 is six, so as to maximize the amount of information that can be readily interpreted and understood. As discussed above, using fewer than six secondary cells 24 may prove to be insufficient while the number of secondary cells 24 exceeding six becomes difficult to manage and remember.

It has been found that a primary topic, subject or objective could be inserted in the primary central cell 22 and be readily explored as having six prominent qualities, characteristics or features, which could then be inserted into the secondary cells 24. As illustrated in FIG. 1, in a particularly preferred embodiment, the cells 22 and 24 are hexagonal in configuration such that the secondary cells 24 surround the hexagonal primary cell 22 which provides an eloquent and natural format for the matrix 20. The use of the hexagon configuration establishes many useful geometric characteristics as well. Thus, in a particularly preferred embodiment, a central hexagon 22 is surrounded by six secondary cell hexagons 24. These geometric characteristics make possible a visual systems for discovering, interpreting, creating, presenting and comprehending information. Subjects which might otherwise be very complex can thus be visualized and understood more effectively. The process works in much the same way that the human brain does, by arranging clusters or chunks of information, which in turn contain progressively more detailed chunks of information.

The matrix 20 of the present invention provides a tangible method for people to better relate and comprehend information. More importantly, it can establish a unique form of communication between the author or presenter of information and the student or recipient of that information. So, while the hexagon was chosen for the matrix 20 because of its visual impact, it also provides the secondary benefit of presenting six items of information around a seventh item in the center. In so doing, the matrix 20 uses the numbers six and seven to most closely approximate the range of absolute judgement and communicating information, as described above.

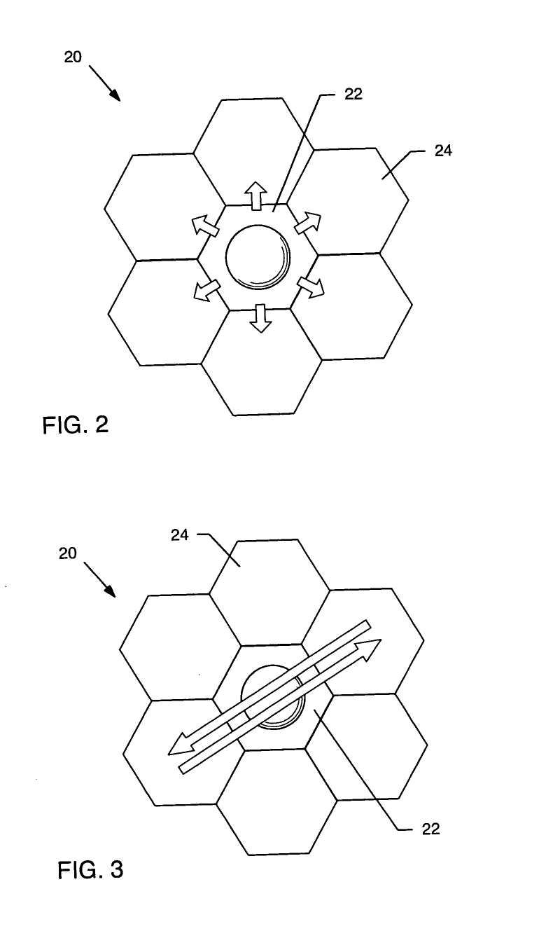

With reference now to FIG. 2, the matrix 20 can be an output device, wherein the item or subject data in the central primary cell 22 is broken apart into six qualities or characteristics which are then inserted into the six surrounding secondary cells 24. The primary objective or subject data within the central primary cell 22 can be interpreted and comprehended more easily due to the organization of the featured characteristic data in the surrounding secondary cells 24.

With reference now to FIG. 3, the matrix 20 can be arranged such that it has a balance format or creates a balanced device. That is, the data or items in the secondary cells 24 can be organized such that dissimilar data is placed on opposite sides of the primary central cell 22 (shown by the directional arrows in FIG. 3) so as to create balance within the matrix 20. Balance is traditionally seen as a trade off between two separate points of view. However, using the matrix system of the present invention provides a structure for envisioning and maintaining dimensional balance between two, three, four, five or even six elements. For example, the process can be very effective when the elements represent diverse interest in a business relationship. If one element is out of balance the entire enterprise can be jeopardized. However, the matrix 20 helps to establish focus towards the objective and the primary cell 22.

For example, the visualization matrix 20 of the present invention could be used to determine product orientation. The product subject data would be inserted into the central primary cell 22. Three separate factors which effect the orientation of products, namely, technology, theme and continuity would need to be considered. The matrix 20 illustrated in FIG. 3 could balance these three factors by inserting “high tech” factors in one secondary cell and “low tech” considerations or factors in a secondary cell 24 on an opposite side of the primary cell 22. “High continuity” and “low continuity” could similarly be set on opposed sides of the primary cell 22, and “high theme” and “low theme” could similarly be placed on opposite sides of the primary cell 22, such that all six secondary cells 24 have information or data contained therein and the entire matrix 20 is balanced.

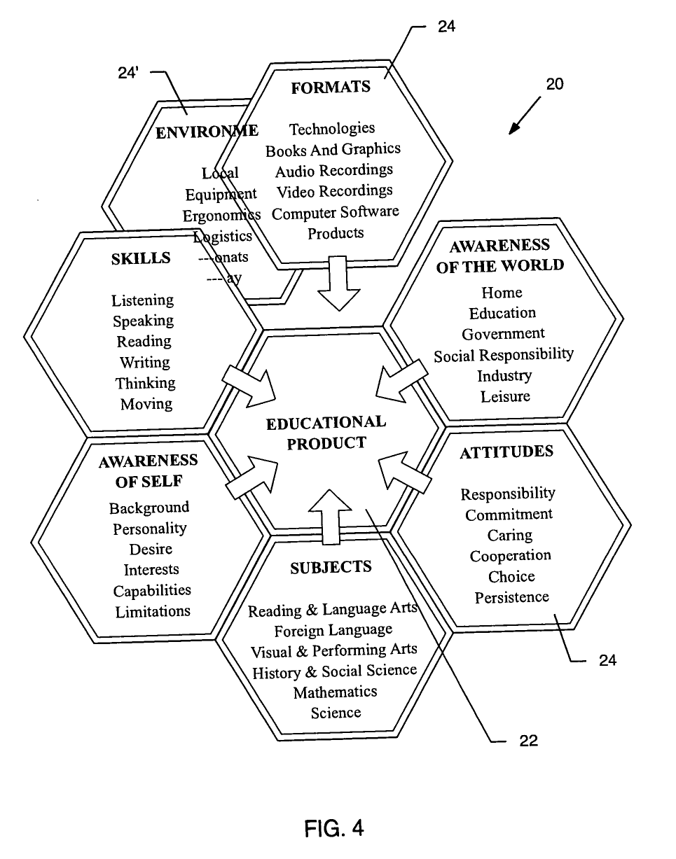

With reference now to FIG. 4, the matrix 20 can comprise an input device wherein six known factors or characteristics are inserted into the secondary cells 24 and compared to one another to derive a primary subject or objective, which is then inserted into the central primary cell 22. These six dominant characteristics in the outer secondary cells 24 surround and define the data or subject matter in the central primary cell 22.

As illustrated in FIG. 4, the configuration of the matrix 20 of the present invention enables the user to easily remove and insert factors or data for a fresh analysis. In FIG. 4, the “formats” data in the secondary cell 24 is being removed and replaced with “environmental” factors of the “educational product” in the primary cell 22. The user of the present invention may determine that an original factor or characteristic is not appropriate or necessary, and should be replaced with another characteristic or factor.

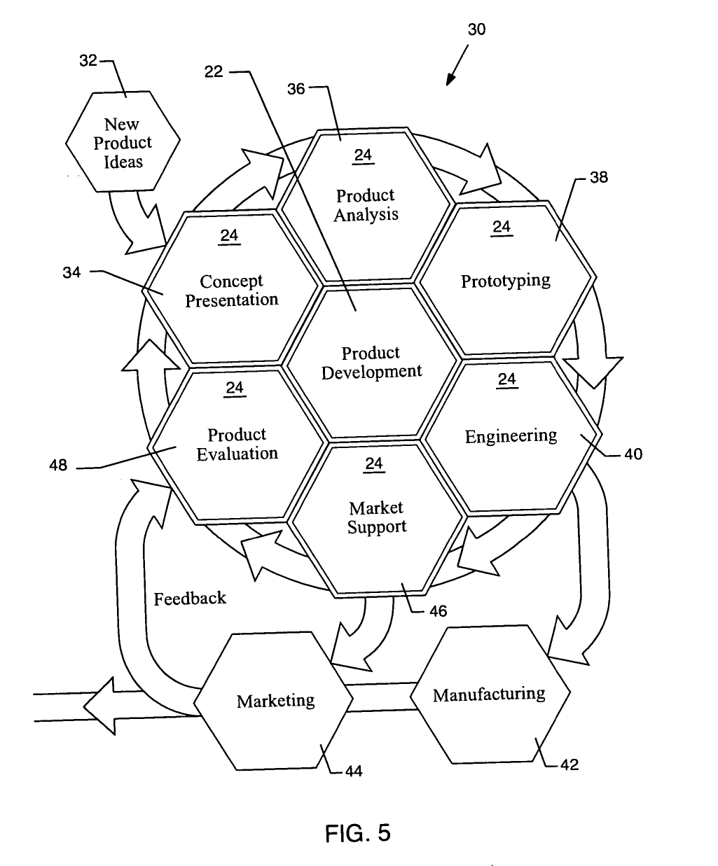

With reference now to FIG. 5, a cycle matrix 30 is illustrated. Such a matrix 30 is particularly useful when the central objective or subject in the primary cell 22 is best depicted in stages. An example of FIG. 5, product development is the main objective or subject, and is placed within the primary cell 22. Of course, product development occurs in various stages. First is the innovation of new product ideas 32. Of these new product ideas, a concept presentation 34 is made, and that data is placed in the appropriate secondary cell 24. Product analysis information 36 is inserted into a secondary cell for analysis of the product development 22. Eventually, prototyping or prototyping considerations 38, will need to be made and can be inserted into yet another secondary cell 24. This will require engineering 40, the data of which is inserted into a secondary cell 24. Manufacturing considerations 42 must be taken into account for product development 22, which will then require marketing 44. Marketing support 46 data is inserted into another secondary cell 24, and marketing support 46 provides feedback or production evaluation data 48. Due to the fact that the “product development” objective in the primary cell 22 occurs in stages, the data or factors to be considered in the secondary cells 24 changes over time. Thus, the data information in one of the secondary cells 24 can be removed, such as concept presentation, as the product is engineered, made ready for manufacturing, and marketing consideration come into play, which considerations and information replace the data in the old secondary cell 24, creating a cyclic device 30. Nonetheless, at any given stage of the product development 22, the pertinent stages and considerations can be easily viewed using the matrix 30 of the present invention without becoming overwhelmed with the entire process.

With reference again to FIG. 4, each of the main data or topics of the secondary cells 24 includes six sub-topics, characteristics, or related data. Although it is possible to list such related sub-topics in this fashion, preferably, as illustrated in FIG. 1, the present invention can be “zoomed” or “expanded” to take into consideration these sub-topics or additional factors. As illustrated in FIG. 1, the data or topics of a given secondary cell 24 would become the data or subject of a primary cell of a sub-matrix. Those factors or characteristics of the original topic in the secondary cell 24 would then be placed in sub-secondary cells 24′. An even smaller matrix could be used to further define and flush out a sub-topic 24′ by inserting that sub-topic 24′ into a primary cell of the smaller matrix. This zooming process can be repeated with each progressive sub-topic to produce or discover ever increasing depth of detail. Data or a topic of a sub-cell would become the data or subject of a primary sub-cell or another sub-matrix.

Although FIG. 1 illustrates the zooming effect in one secondary cell 24, this is not the only format for expanding the information. If done manually, in order to be legible and easily read and interpreted, the topic or information in a given secondary cell 24 would be inserted into a entirely new matrix. As a computer program, the zoom-in effect could happen as the user clicks on a secondary cell 24 or a sub-topic cell of whatever level of matrix desired. The user could zoom-out as well to maintain a broad overview of the subject. The ability to zoom-in and out is important to ensure that specific details are in keeping with objectives of the original concept and also for maintaining flexible pathways of understanding. The zooming-in or expansion and contraction could be applied to any of the embodiments of the present invention.

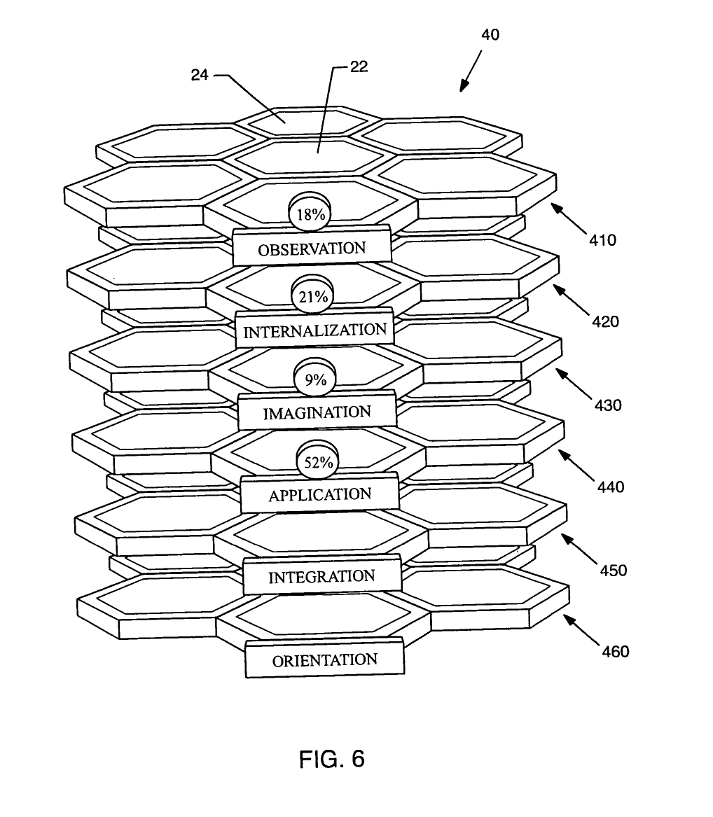

With reference now to FIG. 6, individual matrices 410-460 can be layered or stacked upon one another to create a stacked matrix 40. Each matrix 410-460 would include a primary central cell 22 and a plurality, typically six, secondary cells 24, as described above. As few as two matrices or as many as deemed necessary may be stacked upon one another depending upon the application. Depending upon the application, the same subject or objective data could be inserted in the primary cell 22 of each matrix 410-460. In this case, the data or characteristics in the surrounding secondary cells 24 could be vertically exchanged with one another, particularly if arranged so as to be related to one another along a vertical plane or axis. Alternatively, each matrix in its given level would address a different aspect of a specific product, service, relationship or enterprise. Each matrix level 410-460 would have the secondary cells 24 for inputting information relating to the primary objective or aspect of that matrix level 410-460. In some applications, the sub-topics or characteristics in the secondary cells 24 could potentially be vertically exchanged to allow a free flow of information and a reinterpretation of the data.

From the foregoing, it will be appreciated that the method and matrix system of the present invention can be applied to a wide range of endeavors, including: strategic planning, problem solving, concept visualization, product development, career orientation analysis, budget analysis, business objective delineation, management training, media presentations, dream charting, etc. The matrix format of the present invention can take a variety of forms such as computer programs, multi-media presentations, “fill in the blank” printed pages, graphic checklists, or dimensional analysis devices. In any event, the matrix 20-40 would be established with a primary central cell 22 and a plurality, typically six, surrounding secondary cells 24. This arrangement provides visual reinforcement for the sorting out of concepts or relationships which may otherwise seem vague or abstract. The matrix 20-40 of the present invention allows users to bring clarity to a given subject by breaking the subject into its vital components and then dealing with each of those components, one at a time. The use of the hexagon configuration provides a visually appealing format and adheres to the number six or seven for maximizing recognition and memory.

A few potential additional applications will now be given using the present invention. With reference to FIG. 4, the present invention may be utilized in creating an educational product. Thus, the objective or goal in the center cell 22 of the visualization matrix 20 is the development of an educational product. In this input application, the matrix 20 facilitates the comparing of various characteristics that might define the future product. In developing a series of products, the matrix 20 acts as a checklist, ensuring the inclusion of all critical elements of a curriculum. Thus, for example, in the sub-topic “subjects” in a secondary cell 24, additional sub-topics would be “reading and language arts”, “foreign language”, “visual and performing arts”, “history and social science”, “mathematics” and “science”. The broad components or sub-topics would include “subjects”, “attitudes”, “awareness of the world”, “formats”, “skills”, and “awareness of self”. Each of these sub-topics could be the subject of an expanded matrix of additional sub-topics in a sub-matrix. This would ensure the inclusion of all critical elements of the curriculum. However, the dozens of different elements would be organized in a manner which would enable the user to handle the information more easily.

Instead of the sub-topics listed above in relation to FIG. 4, the educational products could consider the environments for the educational products would be used which could provide important considerations in the developments of those products. These would include location, equipment, ergonomics, logistics, formats, and safety. Each of these sub-topics could include further sub-topics to expand or zoom-in the matrix, as described above. For example, in the “formats” topic, the sub-topics could include: technologies, books and graphics, audio recordings, video recordings, computer software and products.

With reference now to FIGS. 6-12, a temperament, aptitude and personality (TAP) predictor is illustrated incorporating the matrix of the present invention. The TAP would assist in the discovery of an individual's temperament, aptitude and personality. The system is useful in any area of life where understanding of human characteristics and capabilities is important. These include child guidance and child development, educational evaluation and counseling, capability charting and career choice, business and professional relationships, international and cultural activities, and interaction with family and friends. The TAP predictor also provides the methods for recognizing, understanding and appreciating the unique characteristics of others.

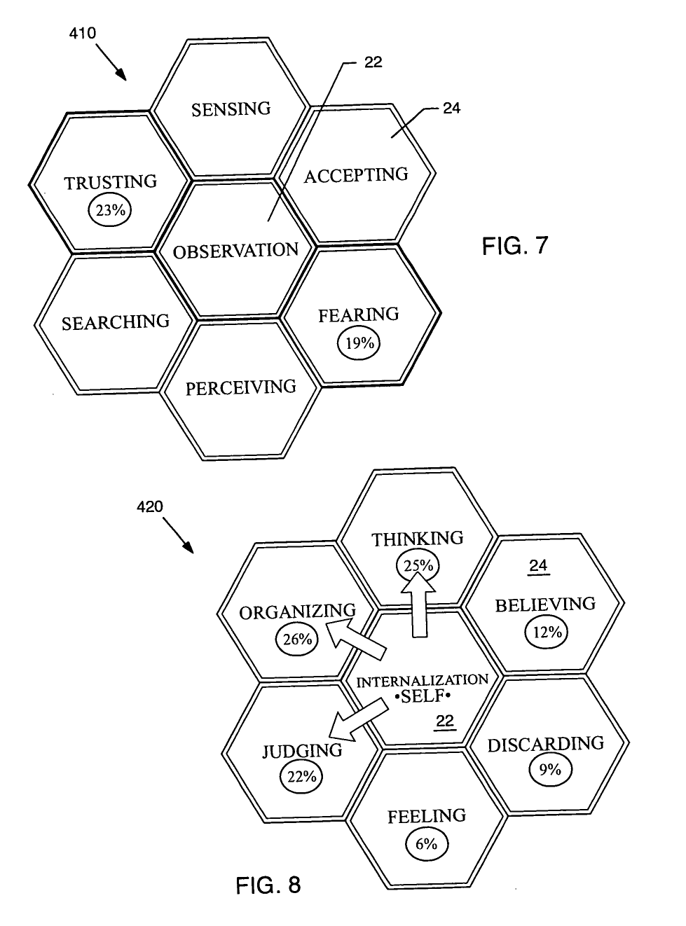

With reference now to FIG. 7, the first level 410 of the TAP predictor measures and displays the various characteristics of the primary subject of observation 22. These aspects (accepting, fearing, perceiving, searching, and sensing) represent the ways people gather and receive information or observe and placed in the secondary cells 24.

With reference to FIG. 8, the second level 420 displays the computation of internalization characteristics 22. These traits 24 (believing, discarding, feeling, judging, organizing and thinking) define self, or the way people internally process and store the information they receive. This is where opinions and attitudes are formed.

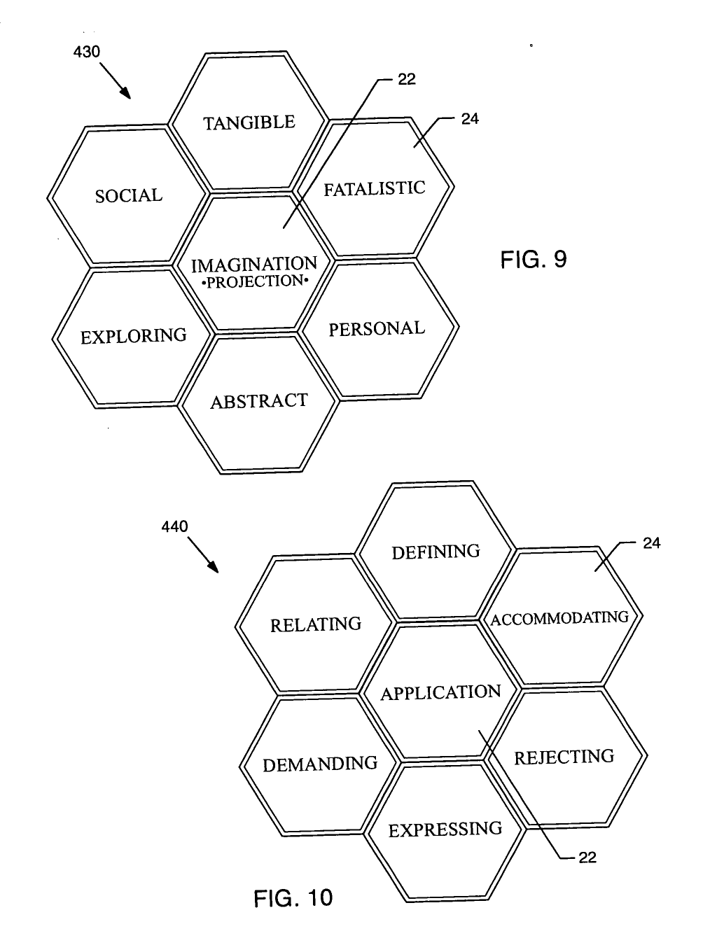

With reference now to FIG. 9, to understand personality, it is critical to look at the human aptitude for imagining. Thus, imagination or projection is the desired objective or subject of the primary cell 22. The components or characteristics of this subject 22 are inserted into the secondary cells 24 and include fatalistic, personal, abstract, exploring, social and tangible. This level embodies dreams, desires, fantasies, goals, plans, prayers and fears. The human ability to imagine can be both positive and negative. Misguided fantasies can contribute to negative or anti-social behavior, just as worthwhile plans can form the basis for accomplishment. Ultimately, the strengthening of a positive imagination can lead to future creativity, productivity and success.

The fourth level 440 of TAP predictor defines characteristics of application 22. Such characteristics are defined as accommodating, rejecting, expressing, demanding, relating or defining, which are inserted into the surrounding secondary cells 24. The first three levels of observation, orientation and internalization 410-430 provide the basis for why people do what they do. These output factors represent the way people do things and how they appear to others. The charting of personality, aptitude and temperament begins with the blending of the first four matrix levels 410-440.

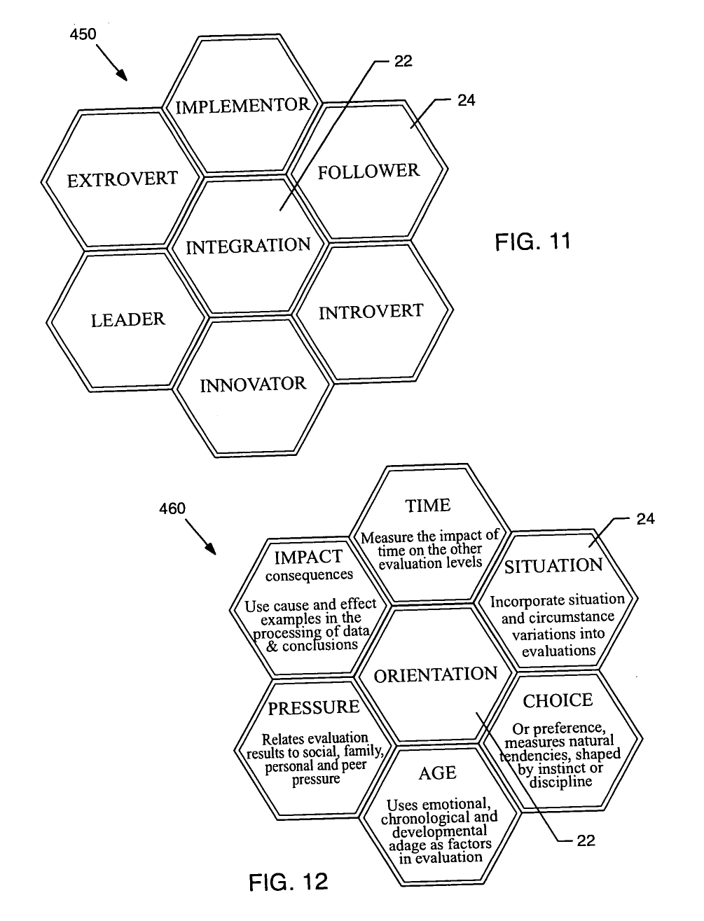

With reference now to FIG. 11, the fifth level matrix 450 uses the integration of the first four levels 410-440 to suggest the personality types. Thus the integration is the primary objective and inserted into the primary cell 22. The personality types are then inserted into the secondary cells 24 and include follower, introvert, innovator, leader, extravert and implementor. A balance of these personality types can also be created by arranging opposite personality types on opposite sides of the integration primary cell 22.

With reference now to FIG. 12, the sixth level matrix 460 defines orientation 22, and is the ultimate qualifier of the other five levels 410-450. Personality evaluations can only be meaningful if seen in the light of these orientation factors (situation, choice, age, pressure, impact and time) 24. They can change the choices and conclusions of the other five levels 410-450 and complete the dimensional matrix 40 needed to show human subtlety and shading.

When stacked vertically, as illustrated in FIG. 6, the topics or data in each of the six hexagon matrices 410-460 have secondary cells 24 with meanings similar to the data or titles in the secondary cells immediately above or below it. For example, the word “accepting” relates to “believing”, “fatalistic”, “accommodating” and “follower” on the next four levels. The six levels which govern the variables as time, situation, choice, age, pressure and impact effect one's orientation on each of the levels.

The TAP predictor is a computation of many individual responses, which indicate personality traits. Traits are represented as percentages in the secondary cells 24 on each level, as illustrated in FIGS. 7 and 8. A total of 100% is allocated to each level and each response contributes to the percentages on various levels. For example, referring to FIG. 8, if asked about the lottery, dedicated lottery players might register 100% in the “feeling” cell 24. These people would stand in line outside a convenience store when the lottery jackpot grows very large. However, for people who have never purchases a lottery ticket, the direction might indicate 100% in the “thinking” cell, revealing that they truly understand the odds of winning. Direction is one of the things that can be most useful to young people who are grappling with complex pressures. The results of the TAP predictor will indicate directions on the matrix 420. Direction indicates the strongest tendencies will show up on the secondary cells 24 of each level 410-460. If the situation involves information from peer groups, the hoped for direction should point to the thinking and judging secondary cells as opposed to the “believing” and “feeling” secondary cells.

With reference to FIG. 7, in the first five levels 410-450 of the TAP predictor, each secondary cell 24 defines a specific feature or characteristics of overall personality, aptitude and temperament. Each feature has an opposite feature, placed on the opposite side of the primary cell 22. For example, “trusting” is the opposite of “fearing” and based upon the results of the test the characteristics of the individual can be computed.

Referring again to FIG. 6, vertical percentages totaling 100% are assigned to the relationship of the first four levels 410-440 of the TAP predictor. The proportions of those percentages define the basic tendencies of an individual to input information, to process information, to dream and imagine, and to output information or be productive. The unhealthy or healthy balance of these percentages at each level can be easily visualized using the stacked matrix 40 of FIG. 6. Early theories can also be made about the individual, such as a high percentage on level 440 (application) may suggest an individual who is very focused on work. The lower percentages on level 410 (observation) and 420 (internalization) might suggest that activities in these areas are basically work related, rather than related to research or education. This theory is further supported by low percentage on level 430 (imagination), which suggests that the work is not entrepreneurial or creative in nature. The person may be found to be a very good worker, who follows instructions without making too many suggestions. Of course these examples and the suggestions regarding them are only assumptions. The only purpose for the suggestions is to show how just one set of measurements can begin to establish some indicators. Combining the vertical percentages with the percentages on the different levels 410-460 establishes a method of viewing the detailed patterns which form an individual's temperament, aptitude and personality.

In an educational setting, the TAP predictor allow each student to develop insight into their own characteristics and potential, to see how those things relate to education and future career choices. The TAP predictor can help students focus their strengths into programs of effective study, while bringing growth to areas of weakness. The TAP predictor can also help identify areas of disappointment, frustration and anger, which if understood and effectively channeled, can be transferred into positive and productive motivation. These otherwise complex components and characteristics can be relatively easily charted and compared to one another using the matrix system of the present invention.

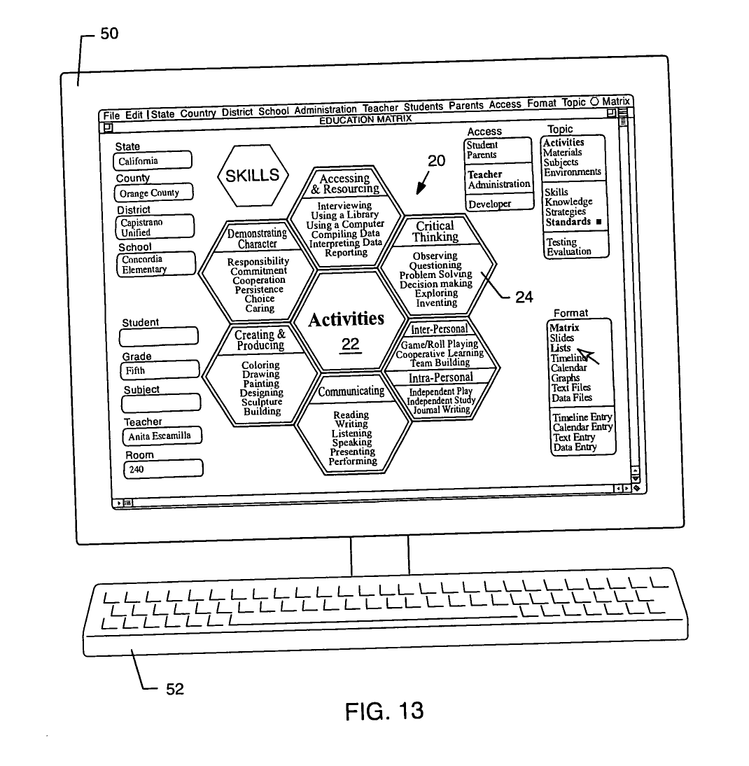

With reference now to FIG. 13, the matrix 20 of the present invention can be utilized in an educational computer program. The matrix 20 can be utilized to create software which would support the establishment of criteria for the development and production of instructional technologies, materials, activities, course work, etc. The computer program could be viewed in a Windows-based format on a computer screen 50 which could be manipulated by a keyboard 52 or other input means such as a track ball or the like. As shown in FIG. 13, the “activities” topic has been selected, causing a matrix 20 to appear on the screen with a listing of sub-topics or component characteristics in the surrounding secondary cells 24 along with yet further sub-topics listed underneath. Such could assist the parent, student or teacher in a variety of ways. For example, the student could select the “subjects” topic which would provide the various courses or subjects available at that time. The student could register for these subjects using the software, or interact with teacher-provided information for a given subject. Study plans or options could be provided to the student or teacher. A parent having access to the program could look into information about his or her son or daughter by filling out windows which could include the student's name, social security number, password, school, city, etc. The parent could then click on various cells 22 and 24 to view the student's grade in a particular subject, view notes from a teacher, activities of a student at school, etc. In this application, clicking or selecting a given primary subject 22 or a secondary topic or subject 24 could lead to a sub-matrix or a list or window of other information for use by the administrator, teacher, student or parent. The aforementioned educational products and TAP predictor could also be administered through the educational program illustrated in FIG. 13.

Although several embodiments of the present invention have been described in detail for purposes of illustration, various modifications of each may be made without departing from the spirit and scope of the invention. Accordingly, the invention is not to be limited, except as by the appended claims.

What is claimed is:

1. A process for visually organizing informational concepts and relationships, the steps comprising:
providing a matrix having a primary cell and two to seven secondary cells surrounding the primary cell;
inserting primary objective or subject data in the primary cell;
inserting data related to the primary objective or subject data into the surrounding secondary cells; and
interpreting and comprehending the primary objective or subject by means of the organization of the related data in the surrounding secondary cells.

2. The process of claim 1, wherein the inserting related data step includes the step of identifying features or characteristics of the primary objective or subject data.

3. The process of claim 1, including the step of identifying the primary objective or subject data based upon a comparison of the related data in the surrounding secondary cells.

4. The process of claim 3, wherein the related data comprises features or characteristics of the primary objective or subject data.

5. The process of claim 1, wherein the number of surrounding secondary cells is six.

6. The process of claim 5, wherein the primary cell and the surrounding cells are hexagonal.

7. The process of claim 1, including the step of layering multiple matrices, each matrix having a primary cell containing primary objective or subject data and two to seven secondary cells including data related to the primary objective or subject data.

8. The process of claim 7, wherein six secondary cells surround the primary cell.

9. The process of claim 8, wherein the primary cell and the surrounding secondary cells in each matrix are hexagonal.

10. The process of claim 7, including the step of assigning the primary cell of each matrix the same objective or subject data, and wherein the surrounding secondary cells of each layer are vertically interchangeable.

11. The process of claim 1, including the steps of inserting the data from a surrounding secondary cell into a primary sub-cell of a sub-matrix, and identifying features and characteristics of the data in the primary sub-cell and inserting identified feature and characteristic data into two to seven surrounding secondary sub-cells of the sub-matrix.

12. The process of claim 11, wherein the number of surrounding secondary sub-cells in the sub-matrix is six.

13. The process of claim 12, wherein the primary cell and the surrounding secondary sub-cells in the sub-matrix are hexagonal.

14. The process of claim 1, including the step of creating a cyclic matrix by removing related data from a surrounding secondary cell and inserting new related data into at least one of the surrounding secondary cells.

15. The process of claim 1, wherein related data are arranged such that dissimilar related data are disposed in secondary cells on generally opposite sides of the primary cell.

16. A process for visually organizing informational concepts and relationships, the steps comprising:
providing a matrix having a primary cell and six secondary cells surrounding the primary cell;
inserting primary objective or subject data in the primary cell;
identifying features or characteristics of the primary objective or subject data;
inserting identified feature or characteristic data into the surrounding secondary cells; and
interpreting and comprehending the primary objective or subject by means of the organization of the feature or characteristic data in the surrounding secondary cells.

17. The process of claim 16, wherein the primary cell and the surrounding secondary cells are hexagonal.

18. The process of claim 16, including the steps of inserting the data from a surrounding secondary cell into a primary sub-cell of a sub-matrix, and identifying features and characteristics of the data in the primary sub-cell and inserting identified feature and characteristic data into six surrounding secondary sub-cells of the sub-matrix.

19. The process of claim 16, wherein data in the secondary cells are arranged such that dissimilar data are disposed in secondary cells on generally opposite sides of the primary cell.

20. A process for visually organizing informational concepts and relationships, the steps comprising:
providing a matrix having a primary cell and six secondary cells surrounding the primary cell;
inserting known data or factors into the surrounding secondary cells;
comparing the known data or factors in the surrounding cells; and
deriving primary objective or subject data based upon the comparison of the known data or factors; and
inserting the derived primary objective or subject data into the primary cell.

21. The process of claim 20, wherein the known data or factors comprise features or characteristics of the primary objective or subject data.

22. The process of claim 20, wherein the primary cell and the surrounding secondary cells are hexagonal.

23. The process of claim 20, including the steps of inserting the data or factor from a surrounding secondary cell into a sub-primary cell of a sub-matrix, and identifying features and characteristics of the sub-primary cell data and inserting identified feature and characteristic data into six surrounding secondary sub-cells of the sub-matrix.

24. The process of claim 16, wherein data or factors in the secondary cells are arranged such that dissimilar data or factors are disposed in secondary cells on generally opposite sides of the primary cell.

25. A process for visually organizing informational concepts and relationships, the steps comprising:
providing a matrix having a primary cell and six secondary cells surrounding the primary cell;
inserting primary objective or subject data in the primary cell;
inserting data related to the primary objective or subject data into the surrounding secondary cells;
providing a second matrix having a primary cell and six secondary cells surrounding the primary cell generally vertically aligned with the primary cell and secondary surrounding cells of the first matrix;
inserting primary objective or subject data in the primary cell of the second matrix;
inserting data related to the primary object or subject data into the surrounding secondary cells of the second matrix; and
interpreting and comprehending the primary objective or subject of each matrix by means of the organization of the related data in the surrounding secondary cells.

26. The process of claim 25, wherein the inserting related data step includes the step of identifying features or characteristics of the primary objective or subject data.

27. The process of claim 25, wherein the primary cell and the surrounding secondary cells are hexagonal.

28. The process of claim 25, including the step of assigning the primary cell of the second matrix the same objective or subject data as the first matrix, and wherein the surrounding secondary cells of each matrix are vertically interchangeable.

29. The process of claim 25, including the steps of inserting the data from a surrounding secondary cell into a primary sub-cell of a sub-matrix, and identifying features and characteristics of the primary data and inserting identified feature and characteristic data into six surrounding secondary sub-cells of the sub-matrix.

30. The process of claim 25, wherein data in the secondary cells are arranged such that dissimilar data are disposed in secondary cells on generally opposite sides of the primary cell.

31. A process for visually organizing informational concepts and relationships, the steps comprising:
providing a matrix having a primary cell and six secondary cells surrounding the primary cell;
inserting primary objective or subject data in the primary cell;
inserting data related to the primary objective or subject data into the surrounding secondary cells;
interpreting and comprehending the primary objective or subject by means of the organization of the related data in the surrounding secondary cells;
cycling the matrix by removing related data from a surrounding secondary cell, and inserting new related data into at least one of the surrounding secondary cells; and
reinterpreting the primary objective or subject data by means of the organization of the related data in the surrounding secondary cells.

32. The process of claim 31, wherein the inserting related data step includes the step of identifying features or characteristics of the primary objective or subject data.

33. The process of claim 31, wherein the primary cell and the surrounding secondary cells are hexagonal.

34. The process of claim 31, including the steps of inserting the data from a surrounding secondary cell into a primary sub-cell of a sub-matrix, and identifying features and characteristics of the data in the primary sub-cell and inserting identified feature and characteristic data into six surrounding secondary sub-cells of the sub-matrix.
